(19) United States
(12) Patent Application Publication
(10) Pub. No.: US 2017/0179743 A1
(43) Pub. Date: Jun. 22, 2017

(54) CHARGE-DISCHARGE MODULE

(71) Applicant: iRice Energy Technology(Shenzhen) Co., Ltd., Shen Zhen (CN)

(72) Inventors: Shih-Hui CHEN, Taoyuan City (TW); Chia-Sheng LIAO, Taoyuan City (TW)

(21) Appl. No.: 14/973,268

(22) Filed: Dec. 17, 2015

(51) Int. Cl. H02J 7/00; H01R 13/73

(52) U.S. Cl. CPC H02J 7/0045; H01R 13/73

(57) ABSTRACT

A charge-discharge module includes a power supply device including a connection port with a first connection terminal set and multiple second connection terminal sets, a secondary battery electrically connected to the first connection terminal set and a switch electrically coupled with the secondary battery and the second connection terminal sets, and a transmission cable including a mating connection port, a charging plug connected to the first mating connection terminal set and multiple discharging plugs respectively connected to the second mating connection terminal sets, and thus, when the connection port and the mating connection port are connected, an external power source and multiple electronic products can be connected to the charge-discharge module at the same time.

### BACKGROUND OF THE INVENTION

1. Field of the Invention

The present invention relates to mobile device protection devices and more particularly, to a charge-discharge module, which consists of a power supply device and a transmission cable so configured that an external power source and multiple electronic products can be connected thereto for charging and discharging.

2. Description of the Related Art

A power supply module of a mobile power supply device generally comprises a charging module controller, a discharging module controller and a secondary battery electrically coupled with the charging module controller, a discharging module controller, and a connection port electrically coupled with the charging module controller and the discharging module controller. The major drawback of this design of power supply module is its bulk size. Regular mobile electronic products, such as mobile phone, digital camera, notebook computer, . . . etc. commonly use a battery to provide the necessary working power supply. When the power of the battery of a mobile electronic product is low and there is no external power supply available, the mobile electronic product becomes unworkable. Thus, a mobile electronic product user usually will carry a mobile power supply device for charging the battery of the mobile electronic product when the power of the battery is low. However, carrying an extra mobile power supply device brings inconvenience to the user.

### SUMMARY OF THE INVENTION

The present invention has been accomplished under the circumstances in view. It is therefore the main object of the present invention to provide a charge-discharge module, which consists of a power supply device and a transmission cable with first and second connection terminal sets provided in a connection port of the power supply device so that when the transmission cable is connected to the power supply device, an external power source and multiple electronic products can be simultaneously connected the charge-discharge module for charging and discharging, bringing convenience.

To achieve this and other objects of the present invention, a charge-discharge module comprises a power supply device and a transmission cable. The power supply device comprises a connection port, a switch and a secondary battery. The connection port comprises a first connection terminal set and a plurality of second connection terminal sets. The first connection terminal set is electrically connected to the secondary battery. The switch is electrically coupled with the secondary battery and the second connection terminal sets. The transmission cable comprises a mating connection port, a charging plug and a plurality of discharging plugs. The mating connection port comprises a first mating connection terminal set and a plurality of second mating connection terminal sets. The charging plug comprises a first plug terminal set. Each discharging plug comprises a second plug terminal set. The first plug terminal set and the second plug terminal sets are respectively electrically connected to the first mating connection terminal set and the respective second mating connection terminal sets. When the connection port of the power supply device is connected to the mating connection port of the transmission cable, the first connection terminal set and the first mating connection terminal set are electrically connected, and, the second connection terminal sets are respectively electrically connected to the second mating connection terminal set. At this time, the user can connect an external power source to the charging plug of the transmission cable to charge the secondary battery, and also connect one or multiple electronic products to the discharging plugs for enabling each connected electronic product to be electrically charge.

In an alternate form of the present invention, the power supply device further comprises a microprocessor. The first connection terminal set, second connection terminal sets, switch and secondary battery of the power supply device are electrically coupled to the microprocessor. Thus, when an external power source is connected to the first connection terminal set, the microprocessor enables the electricity of the external power source to be directly transmitted to the second connection terminal sets to charge each connected electronic product.

### BRIEF DESCRIPTION OF THE DRAWINGS

FIG. 1 is a circuit block diagram of a charge-discharge module in accordance with a first embodiment of the present invention.

FIG. 2 is a circuit block diagram of the first embodiment of the present invention, illustrating the power supply device and the transmission cable electrically connected together and an external power source connected to the transmission cable.

FIG. 3 is a circuit block diagram of the first embodiment of the present invention, illustrating the power supply device and the transmission cable electrically connected together and an electronic device connected to one second plug terminal set.

FIG. 4 is a circuit block diagram of the first embodiment of the present invention, illustrating the power supply device and the transmission cable electrically connected together and an external power source and an electronic device connected to the transmission cable.

FIG. 5 is a circuit block diagram of a charge-discharge module in accordance with a second embodiment of the present invention.

FIG. 6 is a circuit block diagram of the second embodiment of the present invention, illustrating the power supply device and the transmission cable electrically connected together and an external power source connected to the transmission cable.

FIG. 7 is a circuit block diagram of the second embodiment of the present invention, illustrating the power supply device and the transmission cable electrically connected together and an electronic device connected to one second plug terminal set.

FIG. 8 is a circuit block diagram of the second embodiment of the present invention, illustrating the power supply device and the transmission cable electrically connected together and an external power source and an electronic device connected to the transmission cable.

### DETAILED DESCRIPTION OF THE PREFERRED EMBODIMENT

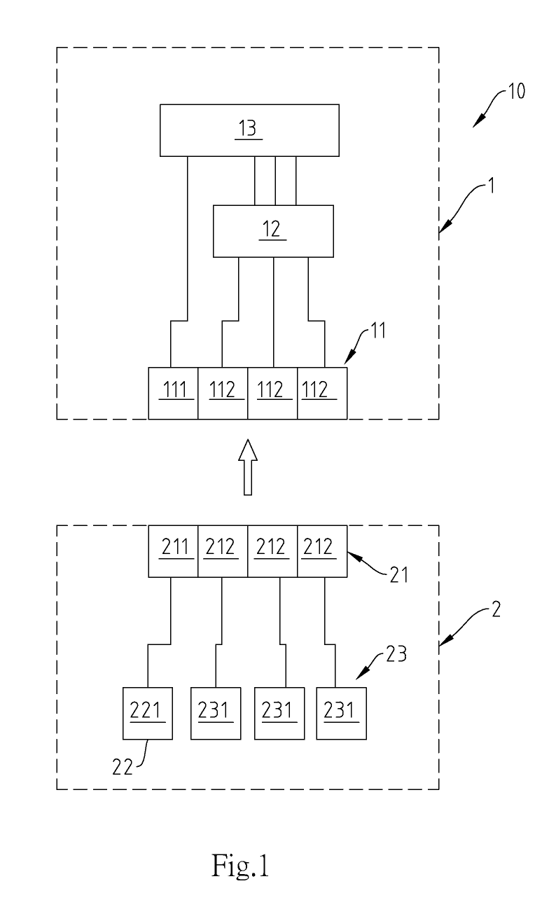

Referring to FIG. 1, a charge-discharge module in accordance with a first embodiment of the present invention is shown. The charge-discharge module 10 comprises a power supply device 1 and a transmission cable 2.

The power supply device 1 comprises a connection port 11, a switch 12 and a secondary battery 13. The connection port 11 comprises a first connection terminal set 111 and a plurality of second connection terminal sets 112. The first connection terminal set 111 is electrically connected to the secondary battery 13. The switch 12 is electrically coupled with the secondary battery 13 and the second connection terminal set 112.

The transmission cable 2 comprises a mating connection port 21, a charging plug 22 and a plurality of discharging plugs 23. The mating connection port 21 is adapted for connection to the connection port 11 of the power supply device 1, comprising a first mating connection terminal set 211 for connection to the first connection terminal set 111 and a plurality of second mating connection terminal sets 212 for connection to the respective second connection terminal sets 112. The charging plug 22 has mounted therein a first plug terminal set 221. Each discharging plug 23 has mounted therein a second plug terminal set 231. The first plug terminal set 221 and the second plug terminal sets 231 are respectively electrically connected to the first mating connection terminal set 211 and the second mating connection terminal sets 212.

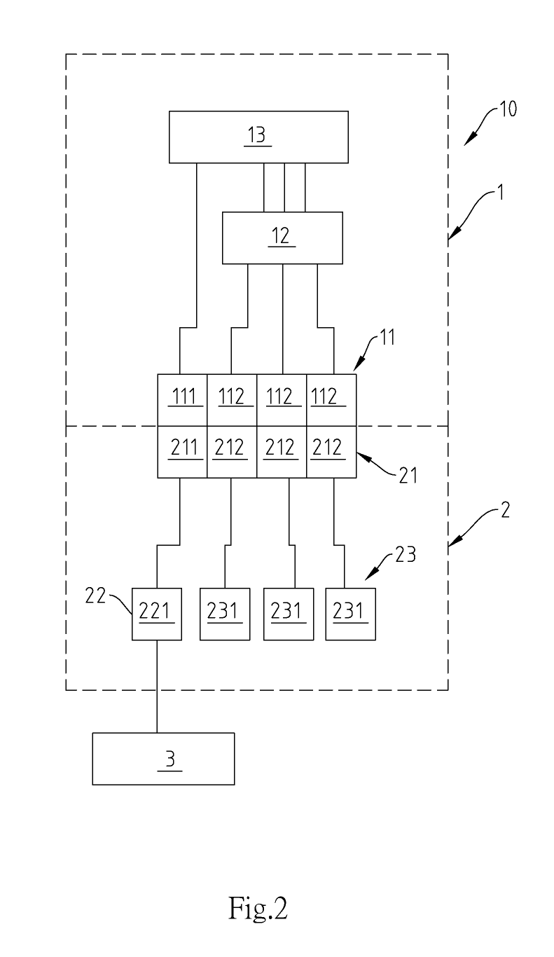

Referring to FIG. 2, the connection port 11 of the power supply device 1 is connected to the mating connection port 21 of the transmission cable 2. When the first plug terminal set 221 of the charging plug 22 is connected to an external power source 3, electric current is guided from the external power source 3 through the first connection terminal set 111 of the connection port 11 to charge the secondary battery 13.

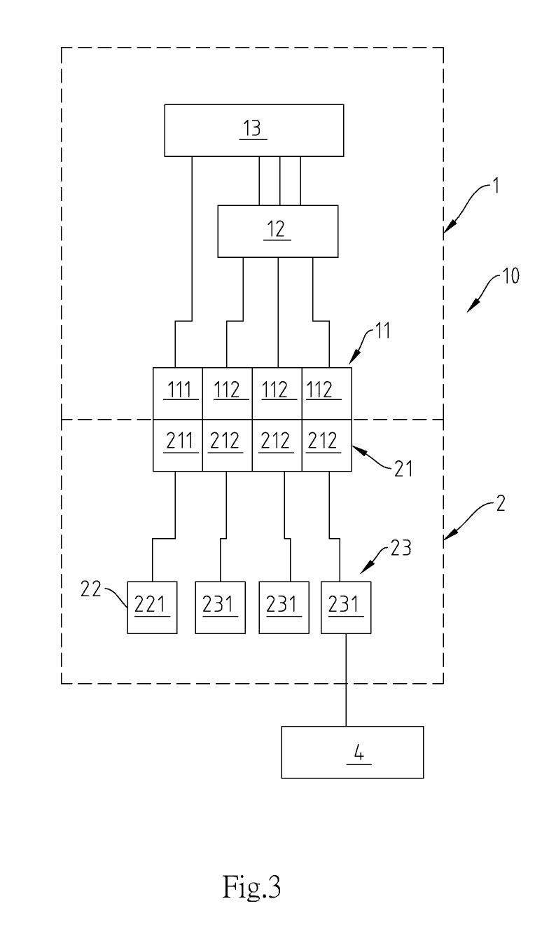

Referring to FIG. 3, the connection port 11 of the power supply device 1 is connected to the mating connection port 21 of the transmission cable 2. When an electronic product 4 is connected to one second plug terminal set 231 of the discharging plug 23, electric current is guided from the external power source 3 through the respective second connection terminal set 112 of the connection port 11 to the respective second plug terminal set 231 and discharged into the electronic product 4 where the switch 12 controls conduction of electric current between the secondary battery 13 and the connection port 11.

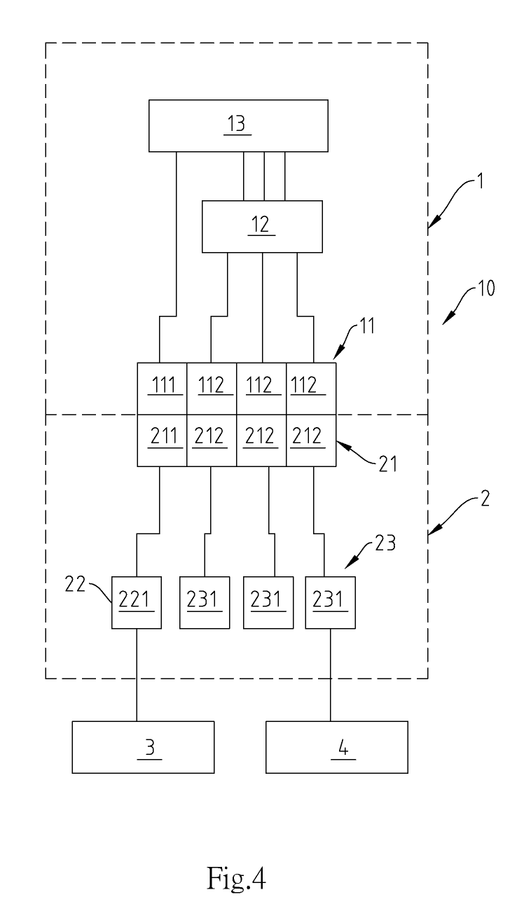

Referring to FIG. 4, the connection port 11 of the power supply device 1 is connected to the mating connection port 21 of the transmission cable 2. When an external power source 3 and an electronic product 4 are respectively connected to the charging plug 22 and the discharging plug 23 and the switch 12 is switched on, the charge-discharge module 10 charges the secondary battery 13 with the external power source 3 and simultaneously discharges electric current into the electronic product 4.

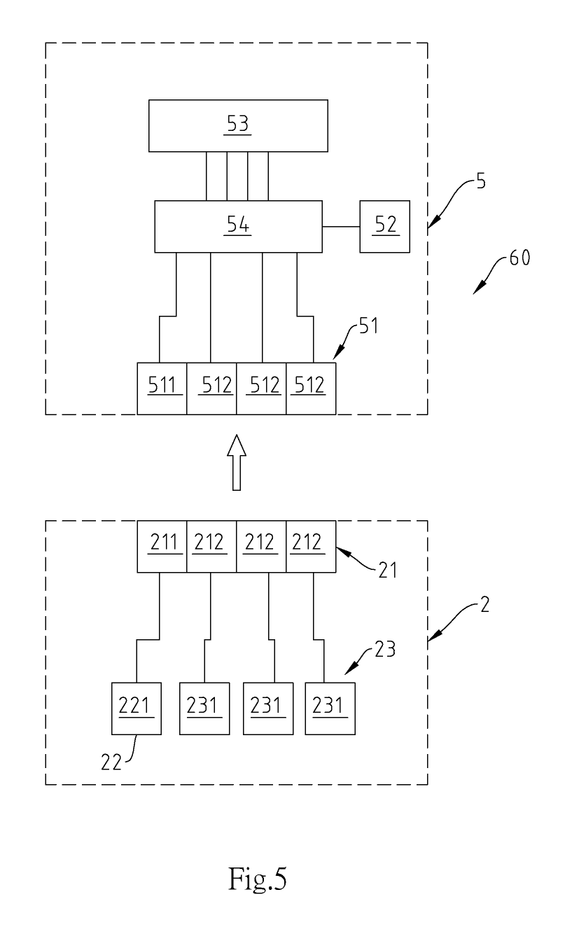

Referring to FIG. 5, a charge-discharge module 60 in accordance with a second embodiment of the present invention is shown. As illustrated, the charge-discharge module 60 comprises a power supply device 5 and a transmission cable 2.

The power supply device 5 comprises a connection port 51, a switch 52, a secondary battery 53 and a microprocessor 54. The connection port 51 comprises a first connection terminal set 511 and a plurality of second connection terminal sets 512. The first connection terminal set 511, the second connection terminal sets 512, the switch 52 and the secondary battery 53 are electrically connected to the microprocessor 54.

The transmission cable 2 comprises a mating connection port 21, a charging plug 22 and a plurality of discharging plugs 23. The mating connection port 21 is adapted for connection to the connection port 51 of the power supply device 5. The mating connection port 21 comprises a first mating connection terminal set 211 adapted for connection to the first connection terminal set 511, and a plurality of second mating connection terminal sets 212 adapted for connection to the respective second connection terminal sets 512. Further, the charging plug 22 has mounted therein a first plug terminal set 221. Each discharging plug 23 has mounted therein a second plug terminal set 231. The first plug terminal set 221 and the second plug terminal sets 231 are respectively electrically connected to the first mating connection terminal set 211 and the respective second mating connection terminal sets 212.

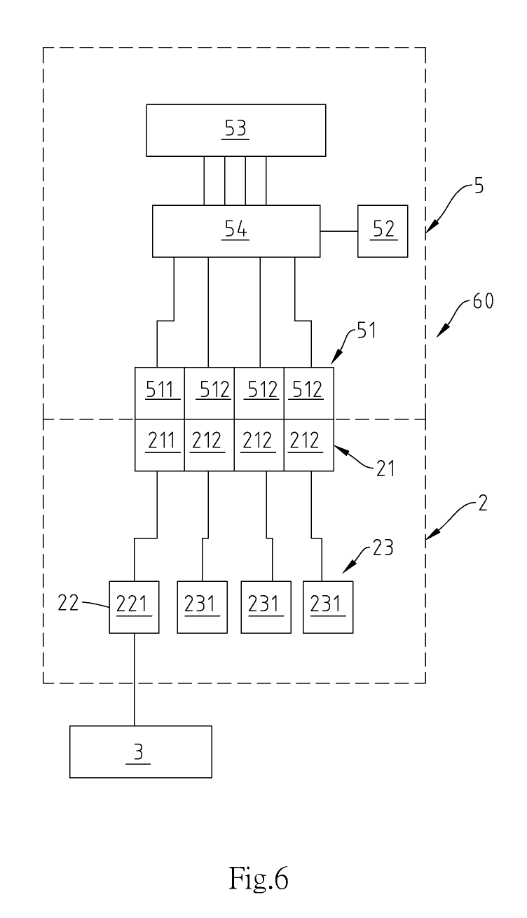

Referring to FIG. 6, the connection port 51 of the power supply device 5 is connected to the mating connection port 21 of the transmission cable 2. When the first plug terminal set 221 of the charging plug 22 is connected to an external power source 3, electric current is guided from the external power source 3 through the first connection terminal set 511 of the connection port 51 to charge the secondary battery 53.

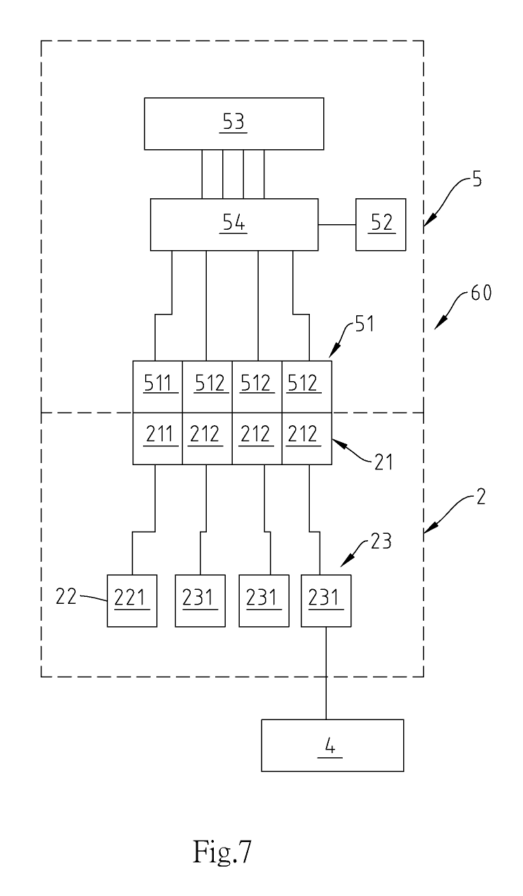

Referring to FIG. 7, the connection port 51 of the power supply device 5 is connected to the mating connection port 21 of the transmission cable 2. When an electronic product 4 is connected to one second plug terminal set 231 of the discharging plug 23, electric current is guided from the external power source 53 through the respective second connection terminal set 512 of the connection port 51 to the respective second plug terminal set 231 and discharged into the electronic product 4 where the switch 52 controls conduction of electric current between the secondary battery 53 and the connection port 51.

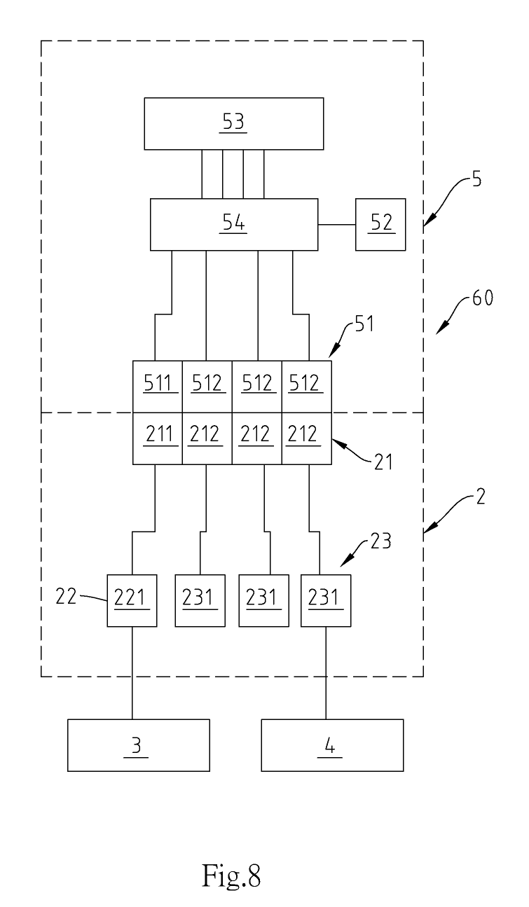

Referring to FIG. 8, the connection port 51 of the power supply device 5 is connected to the mating connection port 21 of the transmission cable 2. When an external power source 3 and an electronic product 4 are respectively connected to the first plug terminal set 221 of the charging plug 22 and one plug terminal set 231 of the discharging plug 23 and the switch 52 is switched on, the microprocessor 54 detects the power of the first connection terminal set 511 and the power of the second connection terminal set 512, and thus one of the following two conditions occurs:

(1) If the power of the first connection terminal set 511 is higher than the power of the second connection terminal set 512 and the microprocessor 54 detects a negative voltage at the second connection terminal set 512, electric current is guided from the external power source 3 through the microprocessor 54 to the second connection terminal set 512 to charge the electronic product 4.

(2) If the power of the first connection terminal set 511 is lower than the power of the second connection terminal set 512, the microprocessor 54 does not transmit electric current from the external power source 3 to the second connection terminal set 512 but transmits electric current from the external power source 3 to charge the secondary battery 53, and at the same time, the microprocessor 54 detects a negative voltage at the second connection terminal set 512 at this time, enabling electric current to be transmitted from the secondary battery 53 to the second connection terminal set 512 to charge the electronic product 4.

What the invention claimed is:

1. A charge-discharge module, comprising:
a power supply device comprising a connection port, a switch and a secondary battery, said connection port comprising a first connection terminal set and a plurality of second connection terminal sets, said first connection terminal set being electrically connected to said secondary battery, said switch being electrically coupled with said secondary battery and said second connection terminal sets; and
a transmission cable comprising a mating connection port, a charging plug and a plurality of discharging plugs, said mating connection port being adapted for connection to said connection port of said power supply device, said mating connection port comprising a first mating connection terminal set adapted for connection to said first connection terminal set and a plurality of second mating connection terminal sets adapted for connection to the respective said second connection terminal sets, said charging plug comprising a first plug terminal set, each said discharging plug comprising a second plug terminal set, said first plug terminal set and said second plug terminal sets being adapted for connection to said first mating connection terminal set and the respective said second mating connection terminal sets.

2. A charge-discharge module, comprising:
a power supply device comprising a connection port, a switch, a secondary battery and a microprocessor, said connection port comprising a first connection terminal set and a plurality of second connection terminal sets, said first connection terminal set, said second connection terminal sets, said switch and said secondary battery being electrically connected to said microprocessor;
a transmission cable comprising a mating connection port, a charging plug and a plurality of discharging plugs, said mating connection port being adapted for connection to said connection port of said power supply device, said mating connection port comprising a first mating connection terminal set adapted for connection to said first connection terminal set and a plurality of second mating connection terminal sets adapted for connection to the respective said second connection terminal sets, said charging plug comprising a first plug terminal set, each said discharging plug comprising a second plug terminal set, said first plug terminal set and said second plug terminal sets being adapted for connection to said first mating connection terminal set and the respective said second mating connection terminal sets.
